(19) United States
(12) Patent Application Publication
(10) Pub. No.: US 2026/0169239 A1
(43) Pub. Date: Jun. 18, 2026

(54) PACKAGE STRUCTURE HAVING PHOTONIC CHIP AND MANUFACTURING METHOD THEREOF

(71) Applicant: INDUSTRIAL TECHNOLOGY RESEARCH INSTITUTE, Hsinchu (TW)

(72) Inventors: Jr-Wei PENG, Hsinchu County (TW); Chih-Cheng HSIAO, Hsinchu County (TW)

(73) Assignee: INDUSTRIAL TECHNOLOGY RESEARCH INSTITUTE, Hsinchu (TW)

(21) Appl. No.: 18/981,104

(22) Filed: Dec. 13, 2024

(51) Int. Cl. G02B 6/42

(52) U.S. Cl. CPC G02B 6/4261; G02B 6/4206; G02B 6/4269

(57) ABSTRACT

A package structure having photonic chip and a manufacturing method thereof. The package structure includes a substrate, an interposer, a photonic chip and a light source. The interposer is disposed on the substrate. The photonic chip is disposed on the substrate. The light source is disposed on the substrate. The interposer is electrically connected to the substrate, the photonic chip and the light source.

### TECHNICAL FIELD

The disclosure relates to a package structure having photonic chip and a manufacturing method thereof.

### BACKGROUND

In general, in a conventional light engine, chips and light sources are electrically connected to the substrate via wire bonding. In addition, in order to prevent a ceramic capillary of a wire bonder from being interfered with the chips or the light sources, the chips and the light sources usually are unable to be disposed in a dense manner.

### SUMMARY

A package structure having photonic chip of an embodiment of the disclosure includes a substrate, an interposer, a photonic chip and a light source. The interposer is disposed on the substrate. The photonic chip is disposed on the substrate. The light source is disposed on the substrate. The interposer is electrically connected to the substrate, the photonic chip and the light source.

A manufacturing method of a package structure having photonic chip of another embodiment of the disclosure includes: proving an interposer; disposing a photonic chip in a recess of a substrate and disposing a submount in the recess of the substrate; disposing the interposer on a mounting surface of the substrate and electrically connecting the interposer to the substrate and the photonic chip, wherein the recess is located on the mounting surface; and disposing a light source on the submount and electrically connecting the interposer to the light source.

A manufacturing method of a package structure having photonic chip of still another embodiment of the disclosure includes: providing an interposer; disposing a photonic chip on a substrate; disposing the interposer on the substrate and electrically connecting the interposer to the substrate and the photonic chip; and disposing a light source on the substrate and electrically connecting the interposer to the light source.

### BRIEF DESCRIPTION OF THE DRAWINGS

The present disclosure will become better understood from the detailed description given herein below and the accompanying drawings which are given by way of illustration only and thus are not intending to limit the present disclosure and wherein:

FIG. 1 is a perspective view of a package structure having a photonic chip according to a first embodiment of the disclosure;

FIG. 2 is an exploded view of the package structure having the photonic chip in FIG. 1;

FIG. 3 is a side cross-sectional view of the package structure having the photonic chip in FIG. 1;

FIGS. 4 to 11 show a manufacturing method of the package structure having the photonic chip in FIG. 1;

FIG. 12 is a perspective exploded view of a package structure having the photonic chip according to a second embodiment of the disclosure;

FIG. 13 is a perspective exploded view of a package structure having the photonic chip according to a third embodiment of the disclosure;

FIG. 14 is a perspective exploded view of a package structure having the photonic chip according to a fourth embodiment of the disclosure;

FIG. 15 is a partially enlarged perspective view of the package structure having the photonic chip in FIG. 14;

FIG. 16 is a perspective exploded view of a package structure having the photonic chip according to a fifth embodiment of the disclosure;

FIG. 17 is a partially enlarged perspective view of the package structure having the photonic chip in FIG. 16;

FIG. 18 is a perspective exploded view of a package structure having the photonic chip according to a sixth embodiment of the disclosure; and

FIG. 19 is a perspective exploded view of a package structure having the photonic chip according to a seventh embodiment of the disclosure.

### DETAILED DESCRIPTION

In the following detailed description, for purpose of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

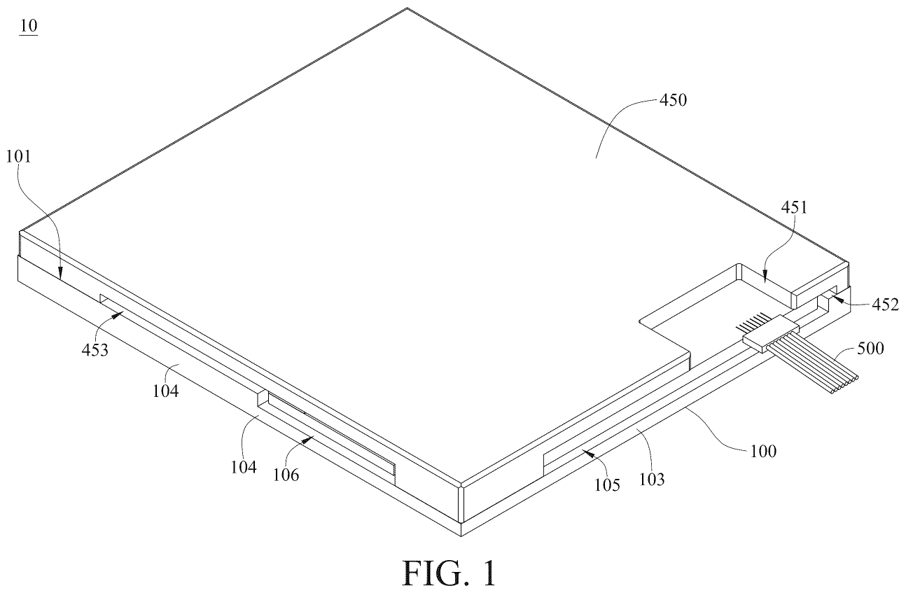

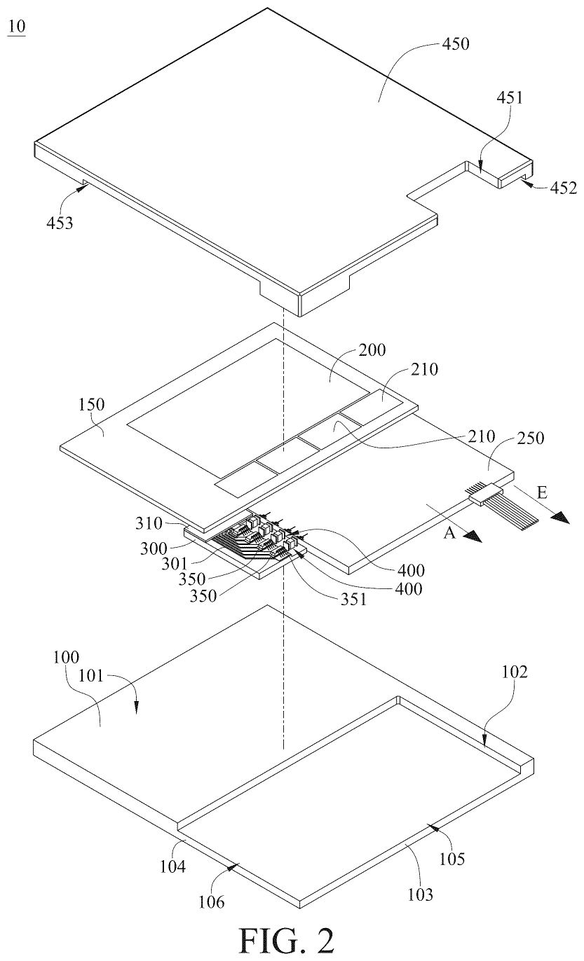

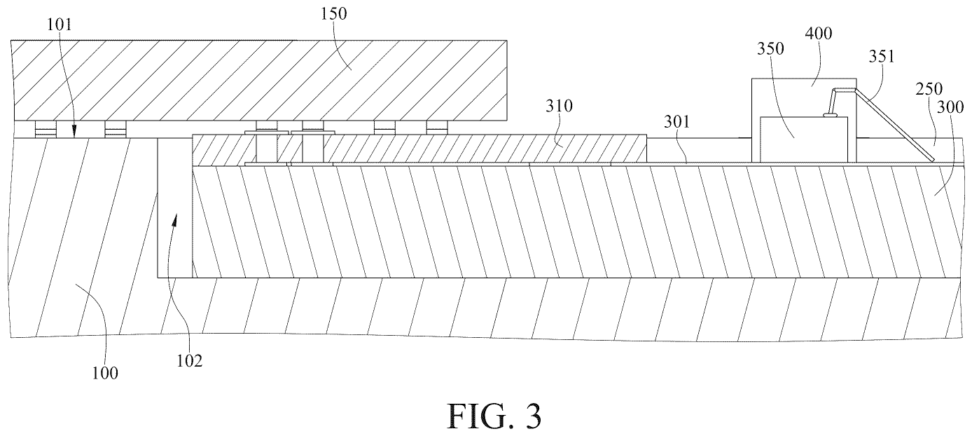

Please refer to FIGS. 1 to 3. FIG. 1 is a perspective view of a package structure 10 having a photonic chip 250 according to a first embodiment of the disclosure. FIG. 2 is an exploded view of the package structure 10 having the photonic chip 250 in FIG. 1. FIG. 3 is a side cross-sectional view of the package structure 10 having the photonic chip 250 in FIG. 1.

In this embodiment, the package structure 10 having the photonic chip 250 includes, for example, a substrate 100, an interposer 150, a plurality of electronic chips 200 and 210 (EIC), the photonic chip 250 (PIC), a submount 300, a plurality of light sources 350, a plurality of optical assemblies 400, a heat sink 450 and an optical fiber assembly 500.

In this embodiment, the substrate 100 is, for example, a circuit board, an integrated circuit carrier, a ceramic substrate, a glass substrate or the like. The substrate 100 has, for example, a mounting surface 101, a recess 102, a first side edge 103, a second side edge 104, a first opening 105 and a second opening 106. The recess 102 is located on the mounting surface 101. The first side edge 103 and the second side edge 104 are located adjacent to each other. The first opening 105 and the second opening 106 are located on the first side edge 103 and the second side edge 104, respectively. The first opening 105 and the second opening 106 are connected to the recess 102. In this embodiment, a step is created by, for example, the recess 102 of the substrate 100.

The interposer 150 is, for example, a redistribution layer (RDL) or a through silicon via (TSV) interposer. The interposer 150 is disposed on the mounting surface 101 of the substrate 100. The electronic chips 200 and 210 are disposed on the interposer 150, and electrically connected to the interposer 150. The electronic chips 200 and 210 may be referred as electronic integrated circuits. The electronic chip 200 is, for example, a digital signal processor (DSP). The electronic chip 210 is, for example, a driving chip or a transimpedance amplifier (TIA).

The photonic chip 250 is, for example, a silicon photonic chip, and may be referred as a photonic integrated circuit. The photonic chip 250 is disposed in the recess 102 of the substrate 100. Further, the first opening 105 is located on a side of the photonic chip 250 located away from the interposer 150.

The submount 300 may be referred as a base or a susceptor, and is, for example, a ceramic substrate or a silicon substrate. The submount 300 is disposed in the recess 102 of the substrate 100. Further, the submount 300 is located between the second opening 106 and the photonic chip 250. The light sources 350 are, for example, laser diode chips or light emitting diodes, and are disposed on the submount 300. As shown in FIG. 3, a pad part 310 may be located between the interposer 150 and the submount 300 to compensate the step formed between the submount 300 and the photonic chip 250, thereby facilitating the interposer 150 to be electrically connected to the photonic chip 250 and the light sources 350. In order to prevent the main point of the disclosure from being obscured, the electronic chips 200 and 210 and the heat sink 450 are omitted from FIG. 3. With the second opening 106, the submount 300 and the light sources 350 are allowed to be disposed in the recess 102 in a convenient manner regardless of the size thereof.

The interposer 150 is electrically connected to the substrate 100, the photonic chip 250 and the light sources 350. Thus, the substrate 100 is allowed to have the recess 102 for the submount 300 and the photonic chip 250 to be disposed therein. In this way, the step created by the recess 102 allows the photonic chip 250 and the light sources 350 on the submount 300 to be disposed in a dense manner, thereby shortening the electrical path from the light sources 350 and the photonic chip 250 to the substrate 100. Moreover, comparing to the related art realizing the electrical connection between the substrate 100 and the photonic chip 250 by through silicon via, it is easier to realize the electrical connection between the substrate 100 and the photonic chip 250 by the interposer 150.

In this embodiment, as shown in FIG. 3, the interposer 150 is electrically connected to the light sources 350 via, for example, a conductive path of the pad part 310 of the submount 300 and a circuit layer 301. Thus, a power required by the light sources 350 may be transferred from the substrate 100 to the light sources 350 via the interposer 150 and the circuit layer 301 of the submount 300. Thus, a wire between the substrate 100 and the light sources 350 is allowed to be omitted, thereby reducing the manufacture cost of the package structure 10 and preventing the crosstalk or wiring offset. In addition, the light sources 350 are, for example, further electrically connected to the circuit layer 301 by a wire 351.

The optical assemblies 400 are disposed on the submount 300, and optically couple the light sources 350 to the photonic chip 250. The optical assemblies 400 may include, for example, one or more optical components, such as lens, isolator or the like. In addition, with the development of the chip package techniques, the accuracy of the alignment between the photonic chip 250, the light sources 350 and the optical assemblies 400 may be ensured while electrically connecting the substrate 100, the photonic chip 250 and the light sources 350 by the interposer 150.

For example, the heat sink 450 is made of a metal material having excellent thermal conductivity, such as stainless steel. The heat sink 450 is thermally coupled to the electronic chips 200 and 210, the photonic chip 250 and the light sources 350, and covers the optical assemblies 400. In this embodiment, the heat sink 450 has, for example, a notch 451 and two side openings 452 and 453. The notch 451 is connected to the side opening 452. The side openings 452 and 453 are located on two adjacent sides of the heat sink 450, respectively. The side opening 452 exposes the photonic chip 250. The side opening 453 exposes the interposer 150 and the submount 300.

For example, the edge coupling technique is used in this embodiment. In detail, the optical fiber assembly 500 is optically coupled to the photonic chip 250 and is disposed in the first opening 105. Thus, the recess 102 connected to the first opening 105 is configured for the photonic chip 250 to be disposed therein while positioning the photonic chip 250. Also, the first opening 105 provides a mistake-proof function for the optical coupling between the photonic chip 250 and the optical fiber assembly 500. Furthermore, the optical fiber assembly 500 is exposed from the notch 451 of the heat sink 450. Thus, the heat sink 450 is prevented from squeezing the optical fiber assembly 500. In this way, the replacement of the optical fiber assembly 500 is facilitated while ensuring the accuracy of the alignment between the optical fiber assembly 500 and the photonic chip 250. Additionally, in this embodiment, a light exiting direction A of the photonic chip 250 is, for example, parallel to an extension direction E of the optical fiber assembly 500. In this embodiment, the optical fiber assembly 500 optically coupled to the photonic chip 250 directly without any additional component. Therefore, the accurate alignment between the optical fiber assembly 500 and the photonic chip 250 is facilitated and the structural complexity of the related components is reduced.

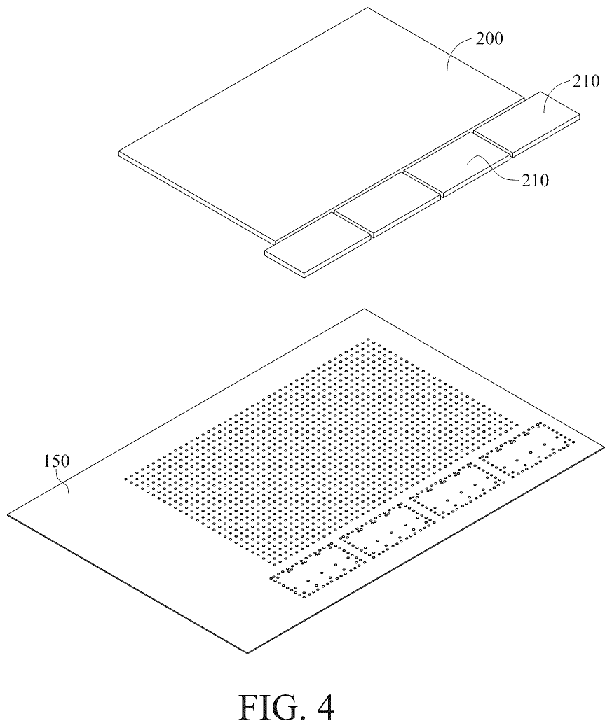

Hereinafter, a manufacturing method of the package structure 10 will be described. Please refer to FIGS. 4 to 11 showing a manufacturing method of the package structure 10 having the photonic chip 250 in FIG. 1.

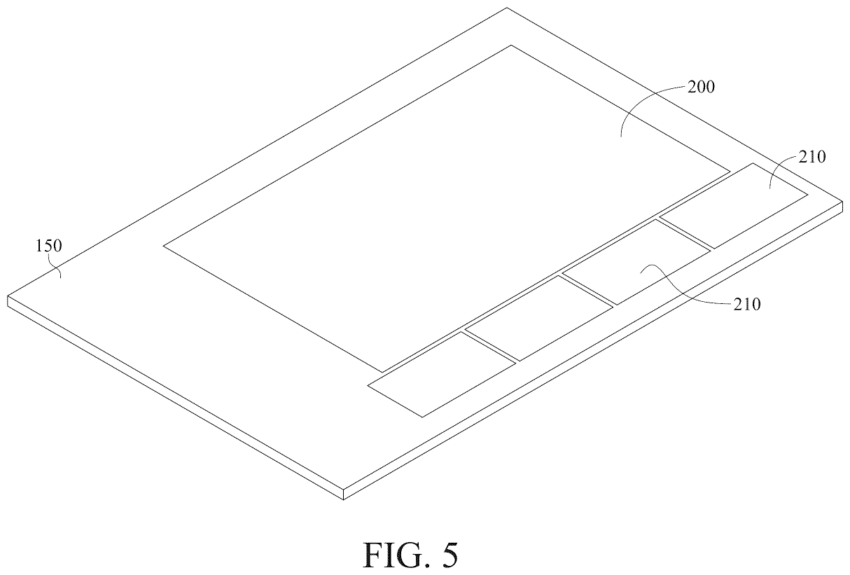

As shown in FIG. 4, the interposer 150 is provided, and the electronic chips 200 and 210 are provided. Then, as shown in FIGS. 4 and 5, the electronic chips 200 and 210 are disposed on the interposer 150. A molding compound surrounding the electronic chips 200 and 210 may be disposed on the interposer 150.

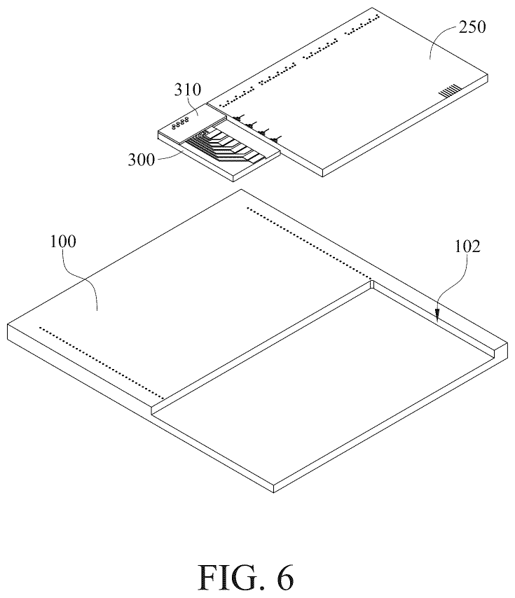

Then, as shown in FIG. 6, the photonic chip 250 is disposed in the recess 102 of the substrate 100, and the submount 300 and the pad part 310 are disposed in the recess 102 of the substrate 100. A molding compound surrounding the photonic chip 250 may be disposed on the substrate 100.

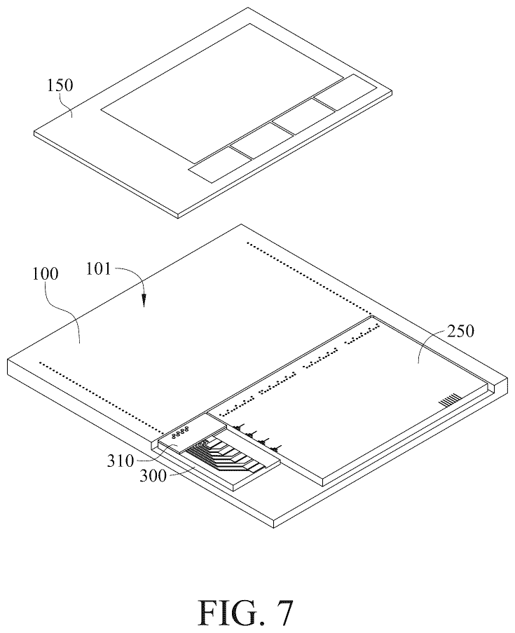

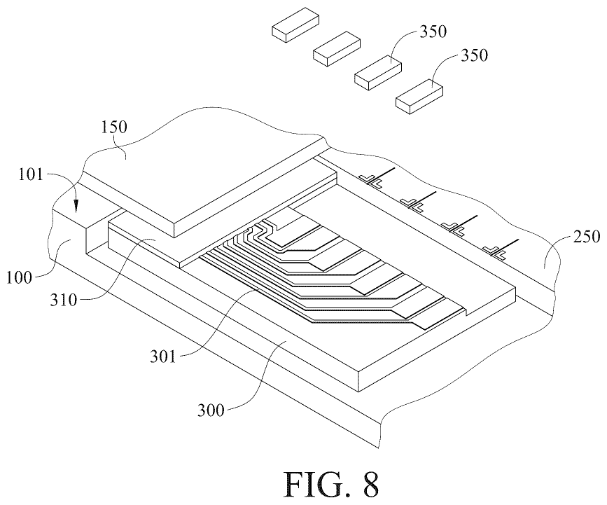

Then, as shown in FIGS. 7 and 8, an interposer 150 is disposed on the mounting surface 101 of the substrate 100, and the interposer 150 is electrically connected to the substrate 100, the photonic chip 250 and the submount 300.

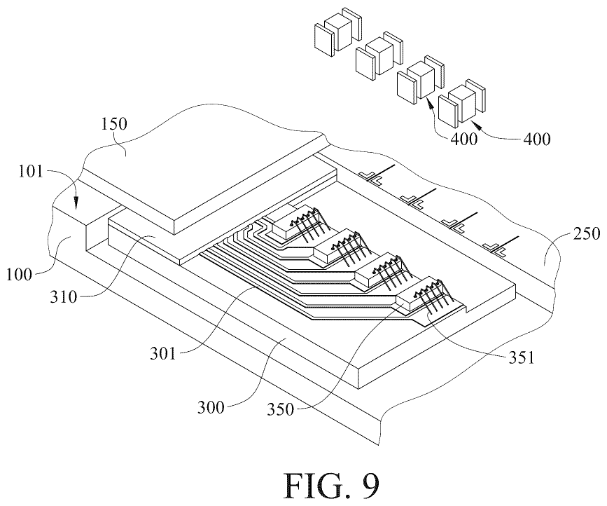

Then, as shown in FIGS. 8 and 9, the light sources 350 are disposed on the submount 300, and the interposer 150 is electrically connected to the light sources 350. The light sources 350 are electrically connected to the interposer 150 via, for example, the circuit layer 301 of the submount 300. The light sources 350 are, for example, further electrically connected to the circuit layer 301 via the wire 351.

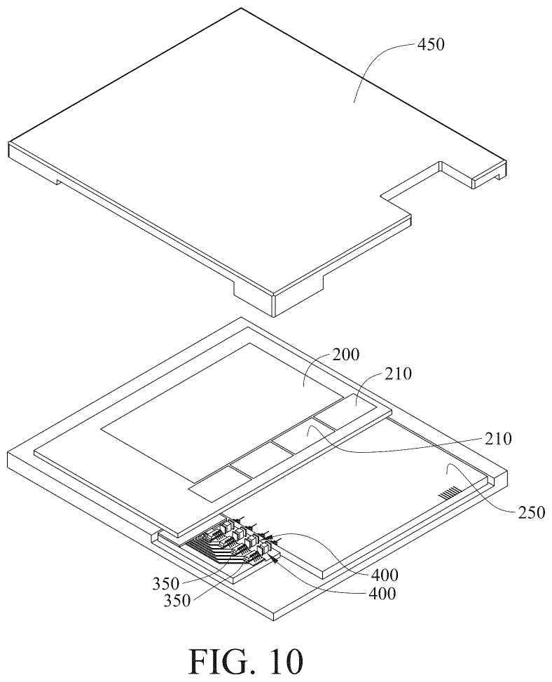

Then, as shown in FIGS. 9 and 10, the optical assemblies 400 are disposed on the submount 300, and the light sources 350 are optically coupled to the photonic chip 250 via the optical assemblies 400. A molding compound surrounding the light sources 350 and the optical assemblies 400 may be disposed on the substrate 100.

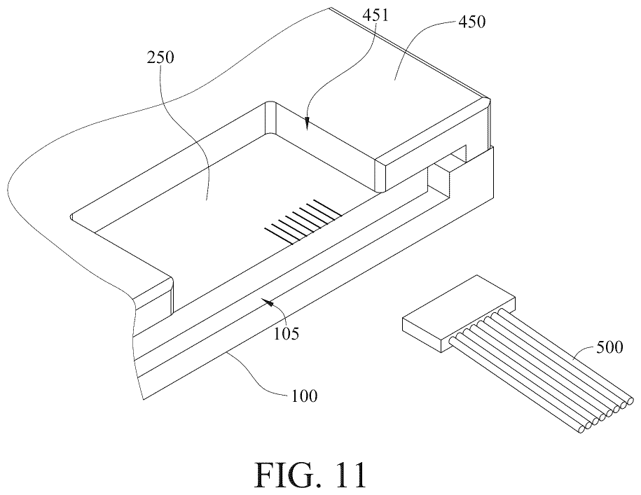

Then, as shown in FIGS. 10 and 11, the heat sink 450 is thermally coupled to the electronic chips 200 and 210, the photonic chip 250 and the light sources 350. The heat sink 450 covers the optical assemblies 400. The heat sink 450 prevents the electronic chips 200 and 210, the photonic chip 250, the light sources 350 and the optical assemblies 400 from being adversely affected by processes related to high temperature, and protects the same from being damaged or polluted in the processes.

Then, as shown in FIGS. 1 and 11, the optical fiber assembly 500 is optically coupled to the photonic chip 250 and disposed in the first opening 105 of the substrate 100. The manufacture of the package structure 10 is completed so far. Since the optical fiber assembly 500 is exposed from the notch 451 of the heat sink 450, when the optical fiber assembly 500 is optically coupled to the photonic chip 250, the optical fiber assembly 500 is allowed to be seen without being covered by the heat sink 450. In this way, the optical fiber assembly 500 is facilitated to be optically coupled to the photonic chip 250. In addition, the optical fiber assembly 500 is exposed from the notch 451 of the heat sink 450, and thus the disclosure is not limited by the order for assembling the heat sink 450 and the optical fiber assembly 500. In other embodiments, the optical fiber assembly 500 may be disposed before the heat sink 450.

Other embodiments are described below for illustrative purposes. It is to be noted that the following embodiments use the reference numerals and a part of the contents of the above embodiments, the same reference numerals are used to denote the same or similar elements, and the description of the same technical contents is omitted. For the description of the omitted part, reference may be made to the above embodiments, and details are not described in the following embodiments.

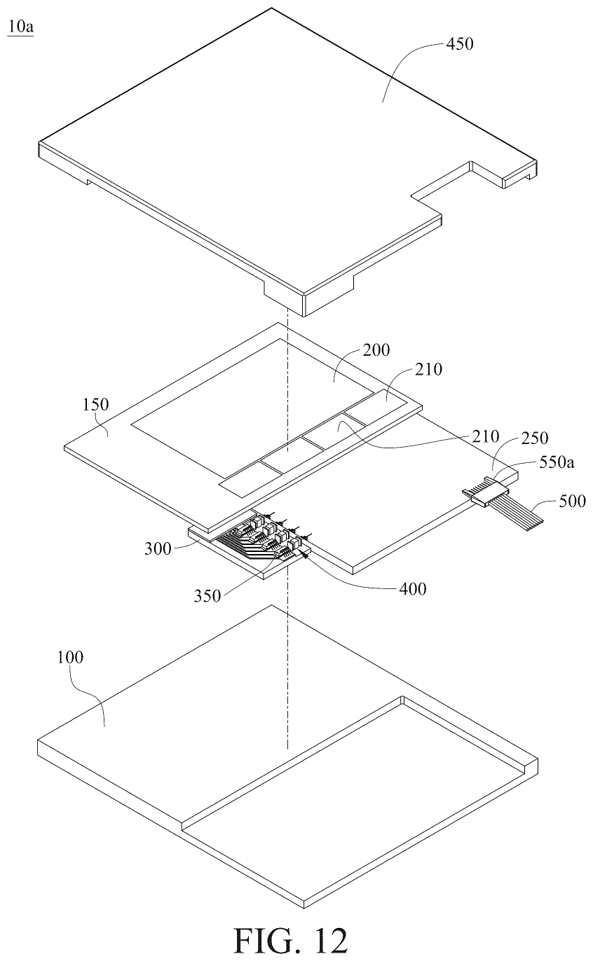

The disclosure is not limited by the arrangement of the optical fiber assembly. Please refer to FIG. 12 that is a perspective exploded view of a package structure 10a having the photonic chip 250 according to a second embodiment of the disclosure. The difference between the package structure 10a of this embodiment and the package structure 10 of the first embodiment is mainly in that: the package structure 10a of this embodiment further includes a socket 550a. The optical fiber assembly 500 is detachably disposed in the first opening 105 via the socket 550a, thereby facilitating the replacement, installation and detachment of the optical fiber assembly 500.

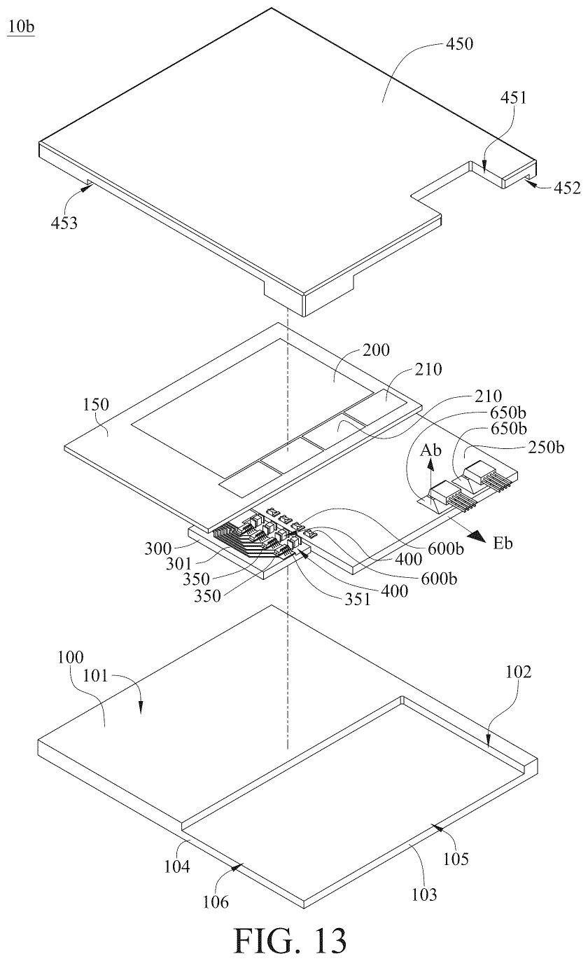

The disclosure is not limited by the light exiting direction of the photonic chip. Alternatively, please refer to FIG. 13 that is a perspective exploded view of a package structure 10b having the photonic chip 250 according to a third embodiment of the disclosure. The difference between the package structure 10b of this embodiment and the package structure 10 of the first embodiment is mainly in that: the package structure 10b of this embodiment further includes a lens assembly 600b and an optical coupling component 650b, and a light exiting direction Ab of the photonic chip 250b is non-parallel (e.g., perpendicular) to an extension direction Eb of the optical fiber assembly 500b. The grating coupling technique is used in this embodiment. The lens assembly 600b and the optical coupling component 650b are disposed on different sides of the photonic chip 250b, respectively. The optical assemblies 400 are optically coupled to the optical fiber assembly 500b via the lens assembly 600b, the photonic chip 250b and the optical coupling component 650b. The optical coupling component 650b is made of transparent materials, such as glass or plastic. The package structure 10b of this embodiment meets the demand for applying the photonic chips 250b of different light exiting directions Ab or the demand for changing optical path, thereby improving the flexibility of the application of the package structure 10b.

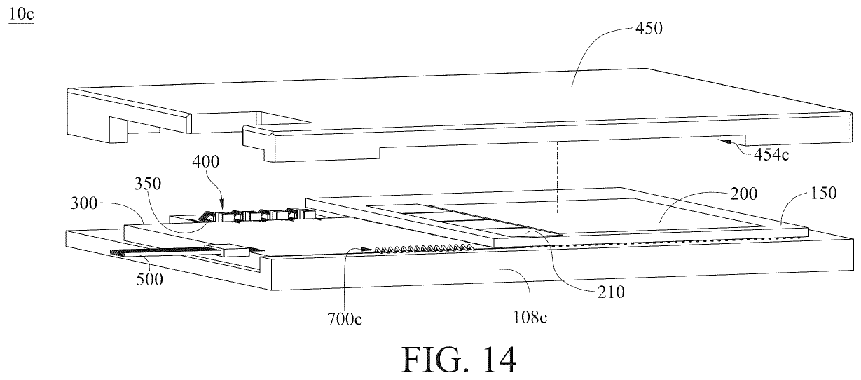

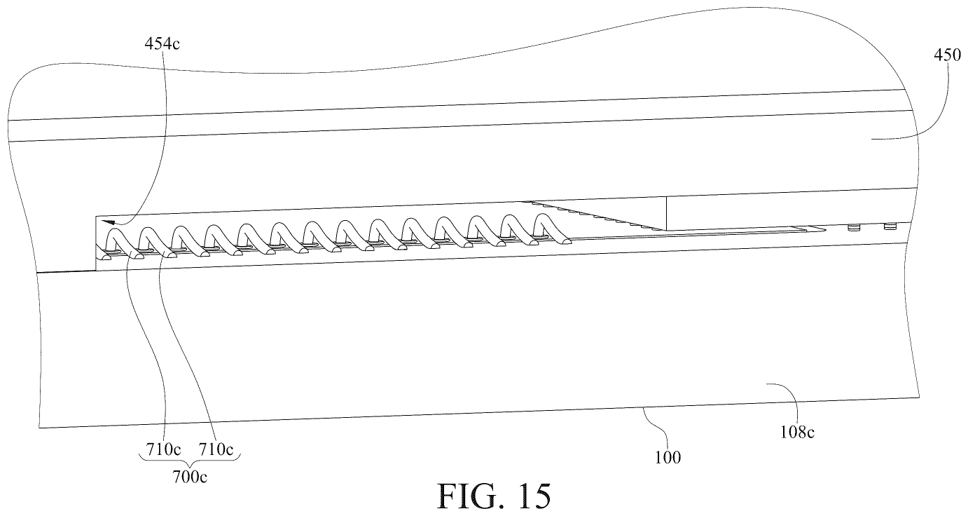

The disclosure is not limited by the manner for realizing the electrical connection between the photonic chip and the substrate. Please refer to FIGS. 14 and 15. FIG. 14 is a perspective exploded view of a package structure 10c having the photonic chip 250 according to a fourth embodiment of the disclosure. FIG. 15 is a partially enlarged perspective view of the package structure 10c having the photonic chip 250 in FIG. 14. The difference between the package structure 10c of this embodiment and the package structure 10 of the first embodiment is mainly in that: the package structure 10c of this embodiment further includes a circuit assembly 700c. The heat sink 450 further has a side opening 454c. The circuit assembly 700c includes, for example, a plurality of gold wires 710c. The gold wires 710c electrically connect the photonic chip 250 and the substrate 100, and are located in the side opening 454c. The gold wires 710c are disposed on, for example, a protrusion 108c of the substrate 100. The photonic chip 250 not only is allowed to obtain power from the substrate 100 via the interposer 150, but also is allowed to obtain power from the substrate 100 via the circuit assembly 700c. Thus, the demand for the power required by the photonic chip 250 having high power consumption is satisfied.

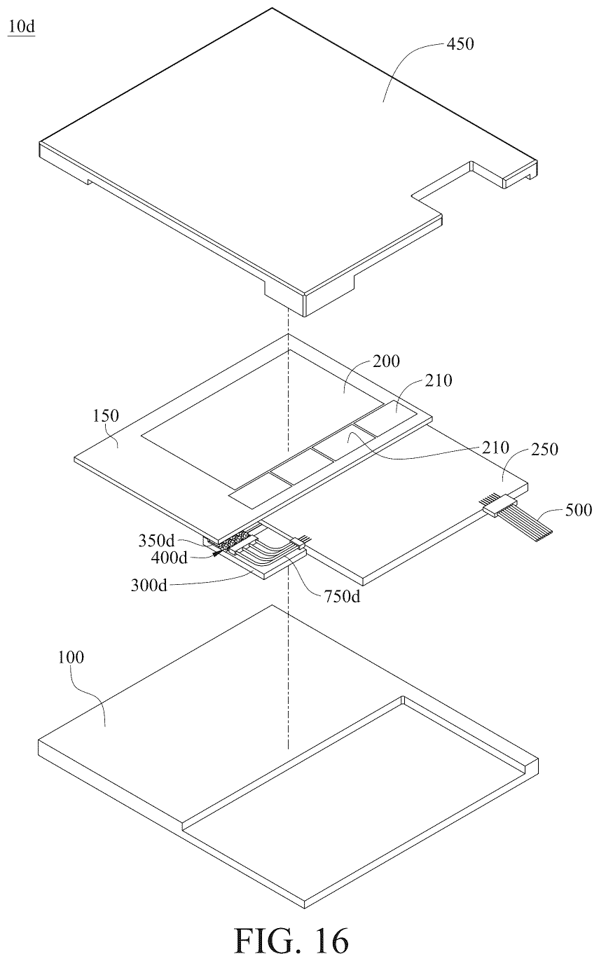

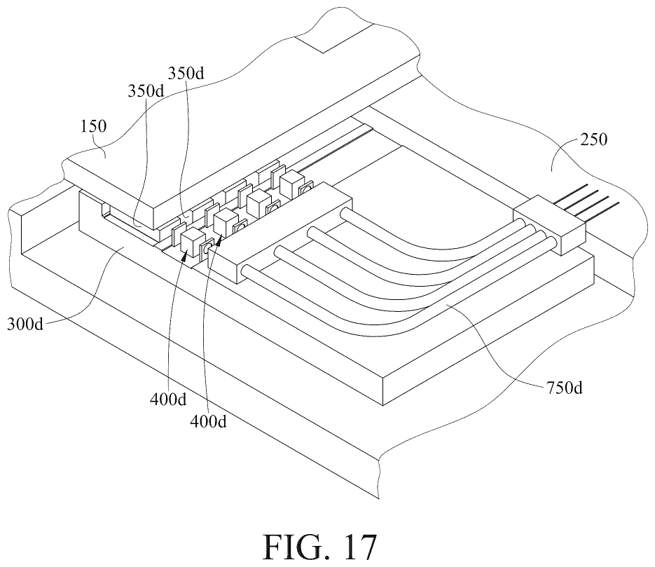

The disclosure is not limited by the manner for realizing the electrical connection between the light sources and the interposer. Please refer to FIGS. 16 and 17. FIG. 16 is a perspective exploded view of a package structure 10d having the photonic chip 250 according to a fifth embodiment of the disclosure. FIG. 17 is a partially enlarged perspective view of the package structure 10d having the photonic chip 250 in FIG. 16. The difference between the package structure 10d of this embodiment and the package structure 10 of the first embodiment is mainly in that: in this embodiment, the light sources 350d are electrically connected to the interposer 150 directly, and is located between the interposer 150 and the submount 300d, which further shortens the electrical path between the interposer 150 and the light sources 350d and thus a more stable power is allowed to be provided to the light sources 350d. The submount 300d may not have the circuit layer 301 in FIG. 1, and thus the design and manufacture of the submount 300d are simplified and more space on the submount 300d may be available for the desired optical components. Further, the package structure 10d may further include an optical fiber assembly 750d, and the optical assemblies 400d may be optically coupled to the photonic chip 250 via the optical fiber assembly 750d.

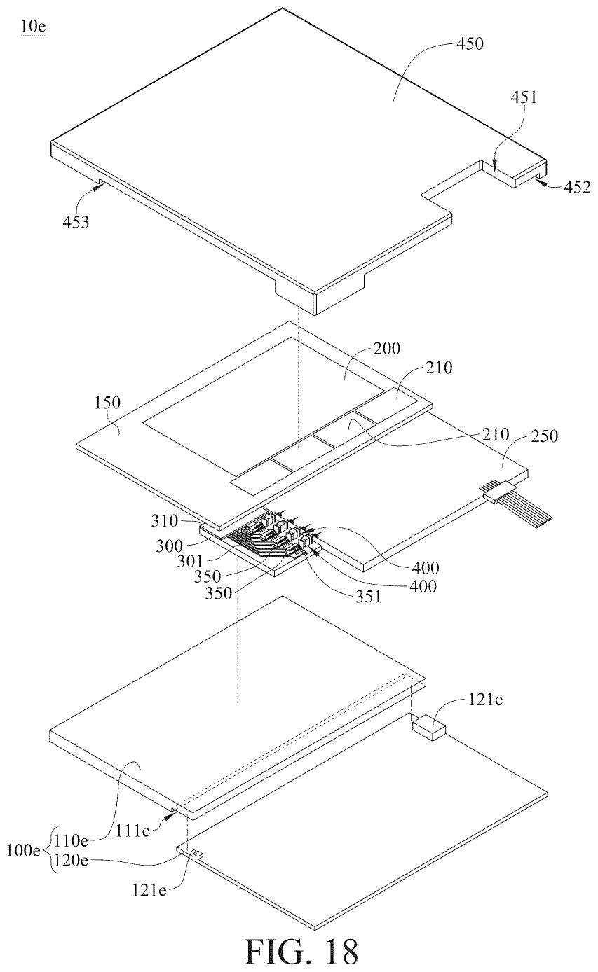

The disclosure is not limited to creating the step by the recess of the substrate. Please refer to FIG. 18 that is a perspective exploded view of a package structure 10e having the photonic chip 250 according to a sixth embodiment of the disclosure. The difference between the package structure 10e of this embodiment and the package structure 10 of the first embodiment is mainly in that: a substrate 100e of the package structure 10 e of this embodiment includes a first plate part 110e and a second plate part 120e. A side of the first plate part 110e has, for example, a positioning recess 111e. A side of the second plate part 120e has, for example, two positioning protrusions 121e. The two positioning protrusions 121e are positioned in the positioning recess 111e so as to hold the first plate part 110e and the second plate part 120e in position. In this embodiment, a step is formed by the first plate part 110e and the second plate part 120e. The interposer 150 and the electronic chips 200 and 210 may be disposed on the first plate part 110e. The photonic chip 250 and the submount 300 may be disposed on the second plate part 120e.

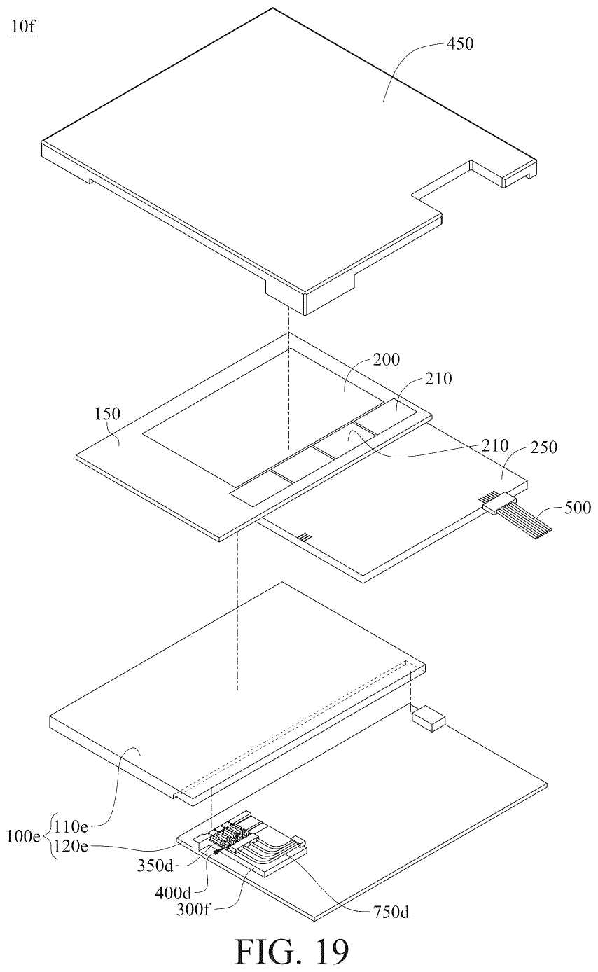

The package structure of the disclosure is not limited to including the submount. Please refer to FIG. 19 that is a perspective exploded view of a package structure 10f having a photonic chip 250 according to a seventh embodiment of the disclosure. The difference between the package structure 10f of this embodiment and the package structure 10d of the fifth embodiment is mainly in that: the package structure 10f of this embodiment replaces the substrate 100 of the package structure 10d by the substrate 100e of the sixth embodiment, and replaces the submount 300d of the package structure 10d by a pedestal 300f. The pedestal 300f and the second plate part 120e are, for example, integrally formed as a single piece. The light sources 350d and the optical assemblies 400d are disposed on the pedestal 300f.

According to the package structure and the manufacturing method thereof disclosed by above embodiments, since the interposer is electrically connected to the substrate, the photonic chip and the light source, the substrate is allowed to have the recess for the submount and the photonic chip to be disposed therein. In this way, the step created by the recess allows the photonic chip and the light source on the submount to be disposed in a dense manner, thereby shortening the electrical path from the light source and the photonic chip to the substrate.

In addition, the interposer is electrically connected to the substrate and the light source. Thus, a power from the substrate is allowed to be transferred to the light source via the interposer. Thus, a wire between the substrate and the light source is allowed to be omitted, thereby reducing the manufacture cost of the package structure and preventing the crosstalk or wiring offset.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A package structure having photonic chip, comprising:
a substrate;
an interposer, disposed on the substrate;
a photonic chip, disposed on the substrate; and
a light source, disposed on the substrate;
wherein the interposer is electrically connected to the substrate, the photonic chip and the light source.

2. The package structure having photonic chip according to claim 1, further comprising a submount, wherein the submount is disposed on the substrate, and the light source is disposed on the submount so as to be disposed on the substrate via the submount.

3. The package structure having photonic chip according to claim 2, wherein the interposer is electrically connected to the light source via the submount.

4. The package structure having photonic chip according to claim 2, wherein the light source is electrically connected to the interposer directly and is located between the interposer and the submount.

5. The package structure having photonic chip according to claim 2, wherein the substrate has a recess and a mounting surface, the recess is located on the mounting surface, the interposer is disposed on the mounting surface, and the photonic chip and the submount are disposed in the recess.

6. The package structure having photonic chip according to claim 5, wherein the substrate further has a first side edge and a first opening, the first opening is located on the first side edge, and the first opening is located on a side of the photonic chip located away from the interposer and is connected to the recess.

7. The package structure having photonic chip according to claim 6, wherein the substrate further has a second side edge and a second opening, the second opening is located on the second side edge and is connected to the recess, the first side edge and the second side edge are located adjacent to each other, and the submount is located between the second opening and the photonic chip.

8. The package structure having photonic chip according to claim 6, further comprising an optical assembly being disposed on the submount and optically coupling the light source to the photonic chip.

9. The package structure having photonic chip according to claim 8, further comprising a heat sink being thermally coupled to the light source and the photonic chip and covering the optical assembly.

10. The package structure having photonic chip according to claim 9, further comprising an optical fiber assembly optically coupled to the photonic chip and disposed in the first opening.

11. The package structure having photonic chip according to claim 10, wherein the heat sink has a notch exposing the optical fiber assembly.

12. The package structure having photonic chip according to claim 10, further comprising a socket, wherein the optical fiber assembly is detachably disposed in the first opening via the socket.

13. The package structure having photonic chip according to claim 10, further comprising a lens assembly and an optical coupling component, wherein the lens assembly and the optical coupling component are disposed on different sides of the photonic chip, respectively, the optical assemblies is optically coupled to the optical fiber assembly via the lens assembly, the photonic chip and the optical coupling component, and a light exiting direction of the photonic chip is non-parallel to an extension direction of the optical fiber assembly.

14. The package structure having photonic chip according to claim 9, wherein the heat sink has a side opening exposing the submount and the interposer.

15. The package structure having photonic chip according to claim 9, further comprising a circuit assembly, wherein the heat sink has a side opening, and the circuit assembly electrically connects the photonic chip and the substrate and is located in the side opening.

16. The package structure having photonic chip according to claim 1, further comprising an electronic chip disposed on the interposer.

17. A manufacturing method of a package structure having photonic chip, comprising:
proving an interposer;
disposing a photonic chip in a recess of a substrate and disposing a submount in the recess of the substrate;
disposing the interposer on a mounting surface of the substrate and electrically connecting the interposer to the substrate and the photonic chip, wherein the recess is located on the mounting surface; and
disposing a light source on the submount and electrically connecting the interposer to the light source.

18. The manufacturing method of the package structure having photonic chip according to claim 17, before disposing the interposer on the mounting surface of the substrate and electrically connecting the interposer to the substrate and the photonic chip, the manufacturing method further comprising:
providing an electronic chip; and
disposing the electronic chip on the interposer.

19. The manufacturing method of the package structure having photonic chip according to claim 17, after disposing the light source on the submount and electrically connecting the interposer to the light source, the manufacturing method further comprising:
disposing an optical assembly on the submount and optically coupling the light source to the photonic chip via the optical assemblies.

20. A manufacturing method of a package structure having photonic chi, comprising:
providing an interposer;
disposing a photonic chip on a substrate;
disposing the interposer on the substrate and electrically connecting the interposer to the substrate and the photonic chip; and
disposing a light source on the substrate and electrically connecting the interposer to the light source.
